(19) United States
(12) Patent Application Publication
(10) Pub. No.: US 2011/0119578 A1
(43) Pub. Date: May 19, 2011

(54) METHOD OF SCROLLING ITEMS ON A TOUCH SCREEN USER INTERFACE

(76) Inventor: Michael U. SCHWARTZ, San Diego, CA (US)

(21) Appl. No.: 12/619,962

(22) Filed: Nov. 17, 2009

(51) Int. Cl. G06F 3/048; G06F 3/041

(52) U.S. Cl. 715/702; 715/786; 345/173

(57) ABSTRACT

A method of scrolling items at a touch screen display is disclosed and may include detecting a first scroll command, scrolling at a first scroll speed, and zooming out to a first zoom level, wherein the first zoom level is associated with the first scroll speed. The method may further include determining whether a second scroll command is detected and scrolling at a second scroll speed if a second scroll command is detected.

### DESCRIPTION OF THE RELATED ART

Portable computing devices (PDs) are ubiquitous. These devices may include cellular telephones, portable digital assistants (PDAs), portable game consoles, palmtop computers, and other portable electronic devices. Many portable computing devices include a touch screen interface in which a user may interact with the device and input commands. Further, the touch screen interface may be used to display multiple items, e.g., application icons, thumbnails, tiles, or a combination thereof. Many displays include scrolling functionality as a way to navigate through the items and locate specific items. Oftentimes, the scrolling functionality may cumbersome and difficult to use.

Accordingly, what is needed is an improved method of scrolling items on a touchscreen user interface.

### BRIEF DESCRIPTION OF THE DRAWINGS

In the figures, like reference numerals refer to like parts throughout the various views unless otherwise indicated.

FIG. 1 is a front plan view of a first aspect of a portable computing device (PCD) in a closed position;

FIG. 2 is a front plan view of the first aspect of a PCD in an open position;

FIG. 3 is a block diagram of a second aspect of a PCD;

FIG. 4 is a first portion of a flowchart illustrating a first aspect of a method of scrolling items on a touch screen user interface commands;

FIG. 5 is a second portion of the flowchart illustrating the first aspect of a method of scrolling items on a touch screen user interface commands;

FIG. 6 is a first portion of a flowchart illustrating a second aspect of a method of scrolling items on a touch screen user interface commands;

FIG. 7 is a second portion of flowchart illustrating the second aspect of a method of scrolling items on a touch screen user interface commands;

FIG. 8 is a third portion of a flowchart illustrating the second aspect of a method of modifying commands;

FIG. 9 is a front plan view of a third aspect of a PCD;

FIG. 10 is a second front plan view of the third aspect of a PCD; and

FIG. 11 is a third front plan view of the third aspect of a PCD.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

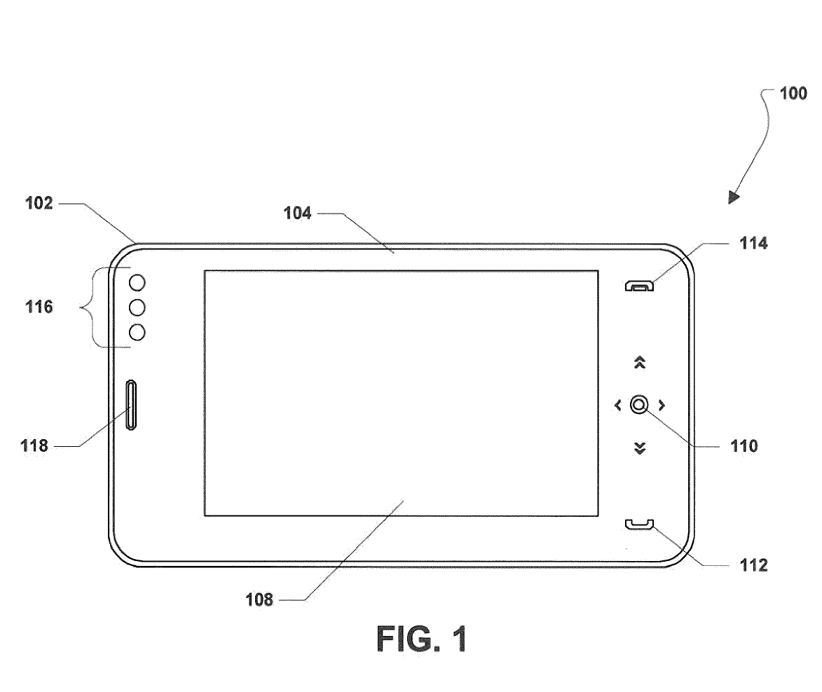

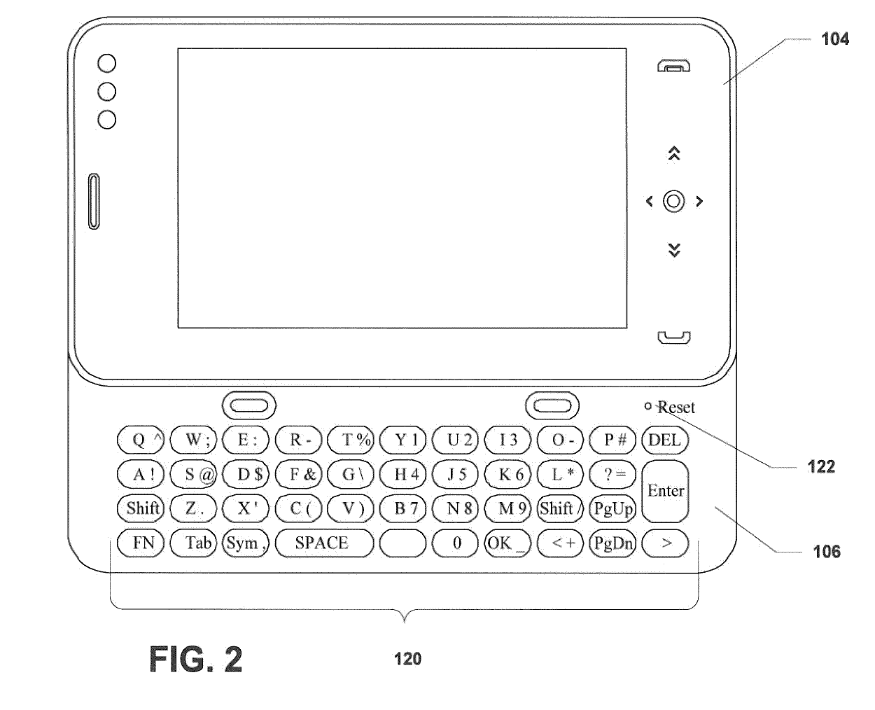

Referring initially to FIG. 1 and FIG. 2, an exemplary portable computing device (PCD) is shown and is generally designated 100. As shown, the PCD 100 may include a housing 102. The housing 102 may include an upper housing portion 104 and a lower housing portion 106. FIG. 1 shows that the upper housing portion 104 may include a display 108. In a particular aspect, the display 108 may be a touch screen display. The upper housing portion 104 may also include a trackball input device 110. Further, as shown in FIG. 1, the upper housing portion 104 may include a power on button 112 and a power off button 114. As shown in FIG. 1, the upper housing portion 104 of the PCD 100 may include a plurality of indicator lights 116 and a speaker 118. Each indicator light 116 may be a light emitting diode (LED).

In a particular aspect, as depicted in FIG. 2, the upper housing portion 104 is movable relative to the lower housing portion 106. Specifically, the upper housing portion 104 may be slidable relative to the lower housing portion 106. As shown in FIG. 2, the lower housing portion 106 may include a multi-button keyboard 120. In a particular aspect, the multi-button keyboard 120 may be a standard QWERTY keyboard. The multi-button keyboard 120 may be revealed when the upper housing portion 104 is moved relative to the lower housing portion 106. FIG. 2 further illustrates that the PCD 100 may include a reset button 122 on the lower housing portion 106.

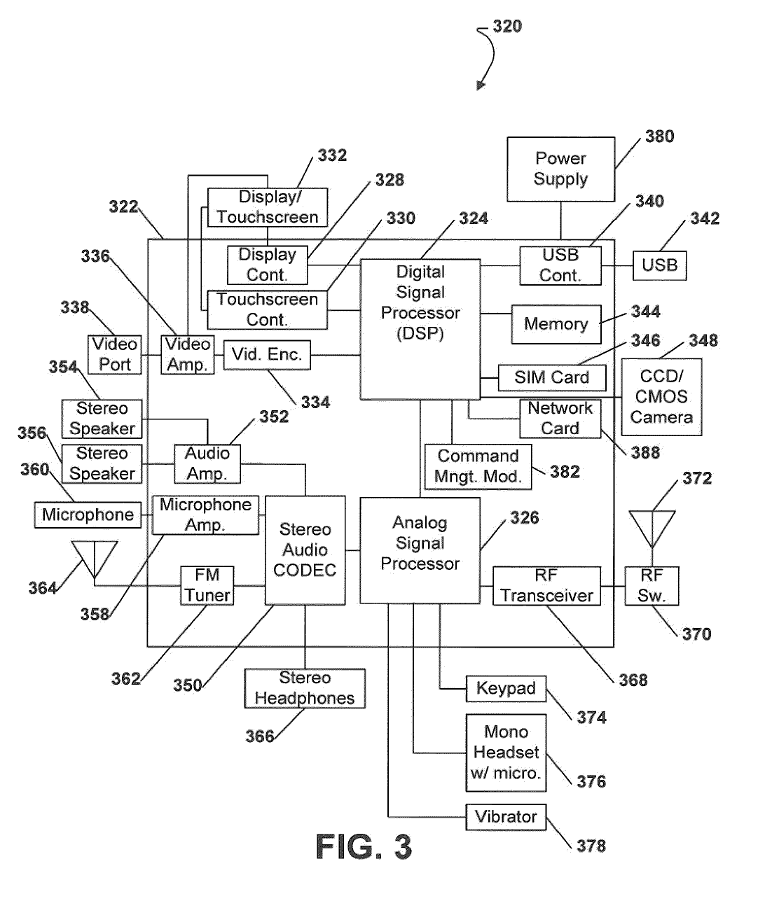

Referring to FIG. 3, an exemplary, non-limiting aspect of a portable computing device (PCD) is shown and is generally designated 320. As shown, the PCD 320 includes an on-chip system 322 that includes a digital signal processor 324 and an analog signal processor 326 that are coupled together. The on-chip system 322 may include more than two processors. For example, the on-chip system 322 may include four core processors and an ARM 11 processor, i.e., as described below in conjunction with FIG. 32.

As illustrated in FIG. 3, a display controller 328 and a touch screen controller 330 are coupled to the digital signal processor 324. In turn, a touch screen display 332 external to the on-chip system 322 is coupled to the display controller 328 and the touch screen controller 330.

FIG. 3 further indicates that a video encoder 334, e.g., a phase alternating line (PAL) encoder, a sequential couleur a memoire (SECAM) encoder, or a national television system(s) committee (NTSC) encoder, is coupled to the digital signal processor 324. Further, a video amplifier 336 is coupled to the video encoder 334 and the touch screen display 332. Also, a video port 338 is coupled to the video amplifier 336. As depicted in FIG. 3, a universal serial bus (USB) controller 340 is coupled to the digital signal processor 324. Also, a USB port 342 is coupled to the USB controller 340. A memory 344 and a subscriber identity module (SIM) card 346 may also be coupled to the digital signal processor 324. Further, as shown in FIG. 3, a digital camera 348 may be coupled to the digital signal processor 324. In an exemplary aspect, the digital camera 348 is a charge-coupled device (CCD) camera or a complementary metal-oxide semiconductor (CMOS) camera.

As further illustrated in FIG. 3, a stereo audio CODEC 350 may be coupled to the analog signal processor 326. Moreover, an audio amplifier 352 may coupled to the stereo audio CODEC 350. In an exemplary aspect, a first stereo speaker 354 and a second stereo speaker 356 are coupled to the audio amplifier 352. FIG. 3 shows that a microphone amplifier 358 may be also coupled to the stereo audio CODEC 350. Additionally, a microphone 360 may be coupled to the microphone amplifier 358. In a particular aspect, a frequency modulation (FM) radio tuner 362 may be coupled to the stereo audio CODEC 350. Also, an FM antenna 364 is coupled to the FM radio tuner 362. Further, stereo headphones 366 may be coupled to the stereo audio CODEC 350.

FIG. 3 further indicates that a radio frequency (RF) transceiver 368 may be coupled to the analog signal processor 326. An RF switch 370 may be coupled to the RF transceiver 368 and an RF antenna 372. As shown in FIG. 3, a keypad 374 may be coupled to the analog signal processor 326. Also, a mono headset with a microphone 376 may be coupled to the analog signal processor 326. Further, a vibrator device 378 may be coupled to the analog signal processor 326. FIG. 3 also shows that a power supply 380 may be coupled to the on-chip system 322. In a particular aspect, the power supply 380 is a direct current (DC) power supply that provides power to the various components of the PCD 320 that require power. Further, in a particular aspect, the power supply is a rechargeable DC battery or a DC power supply that is derived from an alternating current (AC) to DC transformer that is connected to an AC power source.

FIG. 3 indicates that the PCD 320 may include a command management module 382. The command management module 382 may be a stand-alone controller or it may be within the memory 344.

FIG. 3 further indicates that the PCD 320 may also include a network card 388 that may be used to access a data network, e.g., a local area network, a personal area network, or any other network. The network card 388 may be a Bluetooth network card, a WiFi network card, a personal area network (PAN) card, a personal area network ultra-low-power technology (PeANUT) network card, or any other network card well known in the art. Further, the network card 388 may be incorporated into a chip, i.e., the network card 388 may be a full solution in a chip, and may not be a separate network card 388.

As depicted in FIG. 3, the touch screen display 332, the video port 338, the USB port 342, the camera 348, the first stereo speaker 354, the second stereo speaker 356, the microphone 360, the FM antenna 364, the stereo headphones 366, the RF switch 370, the RF antenna 372, the keypad 374, the mono headset 376, the vibrator 378, and the power supply 380 are external to the on-chip system 322.

In a particular aspect, one or more of the method steps described herein may be stored in the memory 344 as computer program instructions. These instructions may be executed by a processor 324, 326 in order to perform the methods described herein. Further, the processors 324, 326, the memory 344, the command management module 382, the display controller 328, the touch screen controller 330, or a combination thereof may serve as a means for executing one or more of the method steps described herein in order to control a virtual keyboard displayed at the display/touch screen 332.

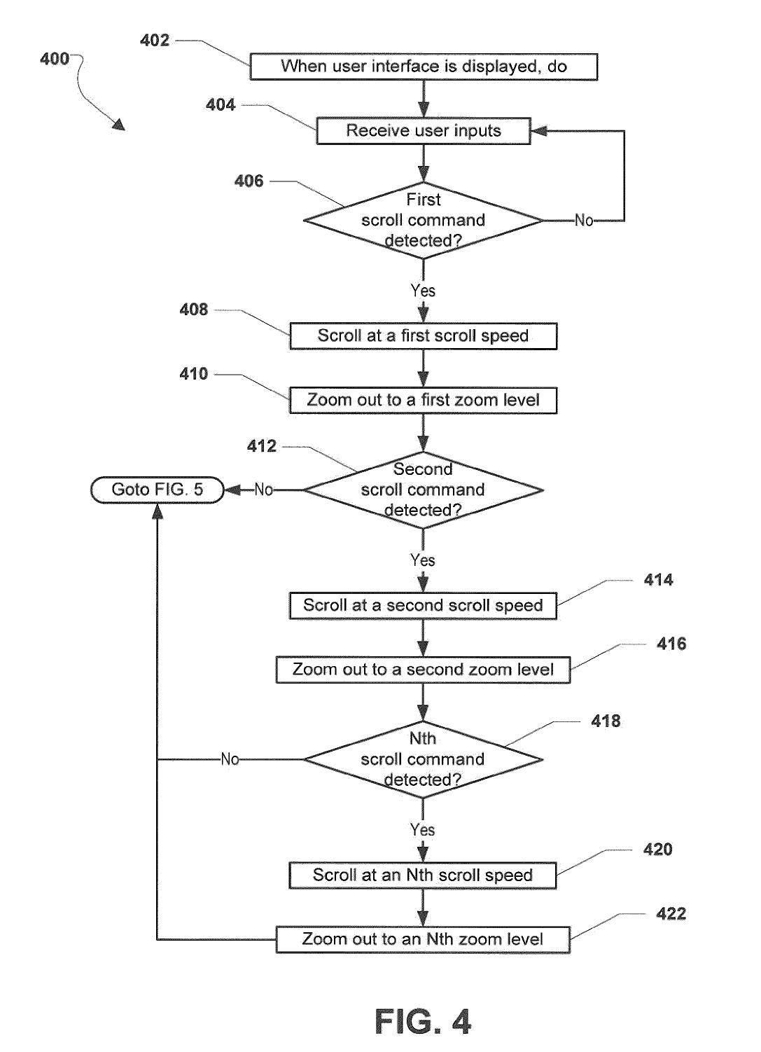

Referring now to FIG. 4, a method of controlling scroll operations within a user interface of an electronic device is shown. Commencing at block 402, a do loop may be entered in which when a user interface is displayed, the following steps may be performed. At block 404, one or more user inputs may be received via the user interface. Moving to decision 406, a command management module may determine whether a first scroll command is detected. If not, the method 400 may return to block 404 and continue as described herein. Otherwise, if a first scroll command is detected, the method 400 may proceed to block 408 and the user interface may scroll through a plurality of items at a first scroll speed. Moreover, at block 410, the user interface may zoom out to a first zoom level. The zoom operation may occur immediately after the scroll command. Alternatively, the zoom operation may occur after a predetermined time of scrolling at the first scroll speed.

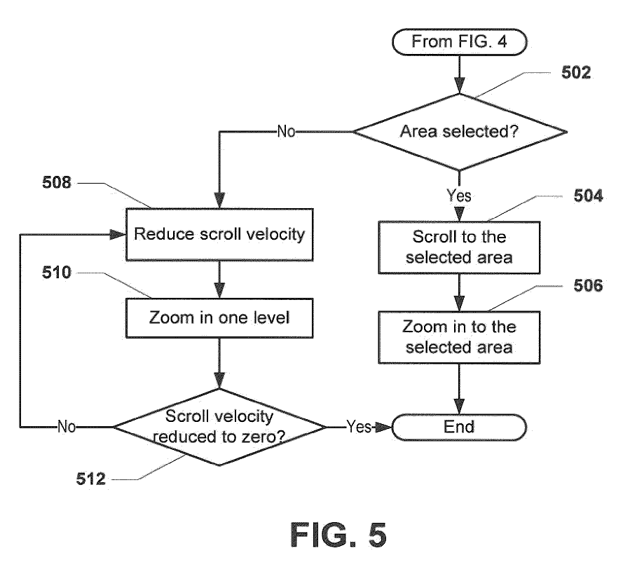

Proceeding to decision 412, the command management module may determine whether a second scroll command is detected. If a second scroll command is not detected, the method 400 may proceed directly to decision 502 of FIG. 5 and the method 400 may continue as described herein. On the other hand, if a second scroll command is detected at decision 412, the method 400 may proceed to block 414 and the user interface may scroll at a second scroll speed. Thereafter, the user interface may zoom out to a second zoom level at block 416.

Continuing to decision 418, the command management module may determine whether an Nth scroll command is detected. If an Nth scroll command is not detected, the method 400 may proceed directly to decision 502 of FIG. 5 and the method 400 may continue as described herein. Conversely, if an Nth scroll command is detected at decision 418, the method 400 may proceed to block 420 and the user interface may scroll at an Nth scroll speed. Next, the user interface may zoom out to an Nth zoom level at block 422. The method 400 may then proceed to decision 502 of FIG. 5. In a particular aspect, there may exist an infinite number of scroll speeds. Alternatively, there may be an optional maximum scroll speed.

At decision 502, the command management module may determine whether an area of the display is selected. If an area is selected, the method 400 may proceed to block 504 and the user interface may scroll to the selected area. Thereafter, at block 506, the user interface may zoom in to the selected area. The method 400 may then end.

Returning to decision 502, if an area is not selected, the method 400 may proceed to block 508 and the scroll velocity may be reduced. Thereafter, at block 510, the user interface may zoom in one level. Moving to decision 512, the user interface, or a controller thereof, may determine whether a scroll velocity is reduced to zero. If the scroll velocity is zero, the method may end. Otherwise, if the scroll velocity is not reduced to zero, the method may return to block 508 and continue as described herein.

In another aspect, decision 512 may include a decision that determines whether a minimum zoom is reached. In such, a case, when a minimum zoom is reached, the method may end. Otherwise, the method may return to block 508 and continue as described herein.

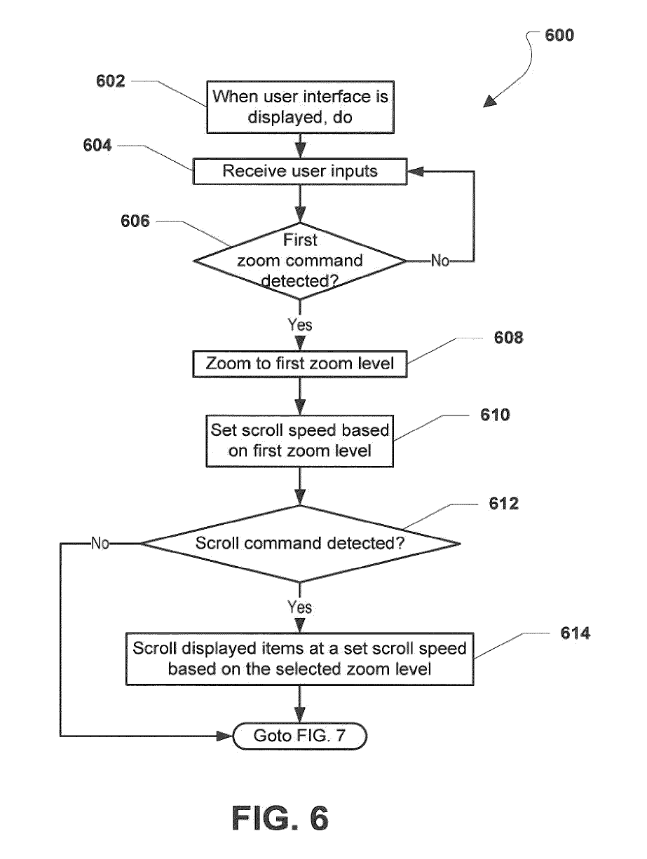

Referring now to FIG. 6, another aspect of a method of controlling scroll operations within a user interface of an electronic device is shown. Beginning at block 602, a do loop may be entered in which when a user interface is displayed, the following steps may be performed. At block 604, one or more user inputs may be received via the user interface. Moving to decision 606, a command management module may determine whether a first zoom command is detected. If a zoom command is not detected, the method 600 may return to block 604 and continue as described herein. On the other hand, if a zoom command is detected at decision 606, the method 600 may proceed to block 608 and the user interface may zoom to a first zoom level. Then, at block 610, the user interface may set a scroll speed based on the first zoom level.

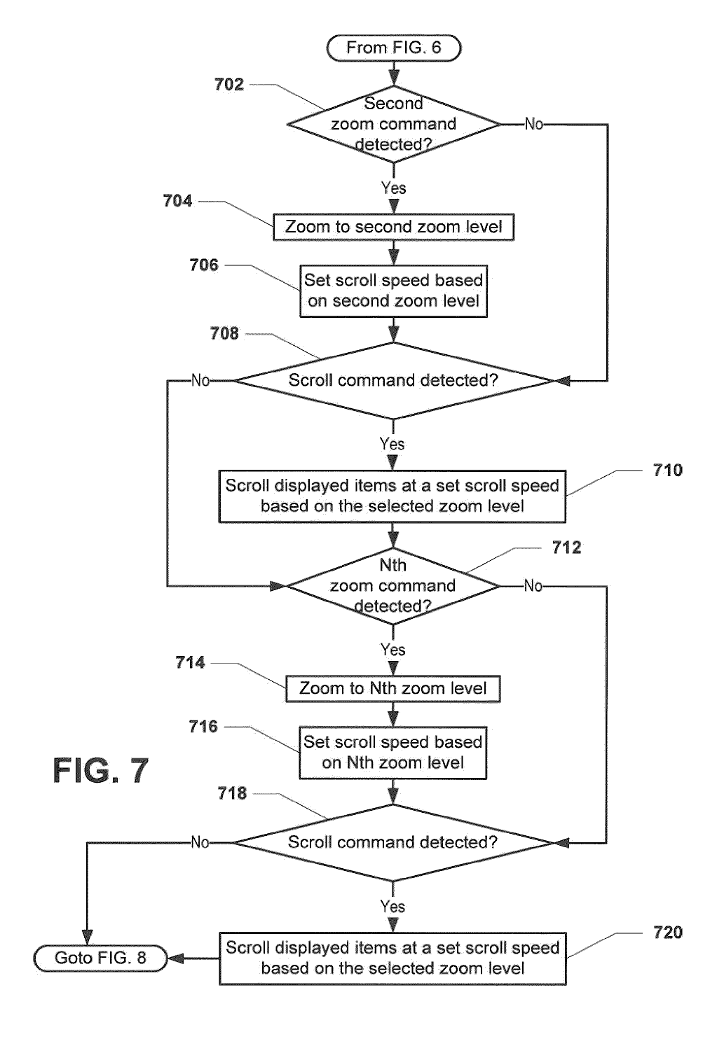

Moving to decision 612, the command management module may determine whether a scroll command is detected. If a scroll command is not detected, the method 600 may continue to decision 702 of FIG. 7. Conversely, if a scroll command is detected, the method 600 may proceed to block 614 and the user interface may scroll displayed items at a set scroll speed based on the selected zoom level. Thereafter, the method 600 may proceed to decision 702 of FIG. 7.

At decision 702 of FIG. 7, the command management module may determine whether a second zoom command is detected. If a second zoom command is detected at decision 606, the method 600 may proceed to block 704 and the user interface may zoom to a second zoom level. Next, at block 706, the user interface may set a scroll speed based on the second zoom level. Thereafter, from block 706, the method 600 may proceed to decision 708 and continue as described herein. Returning to decision 702, if a second zoom command is not detected, the method 600 may proceed directly to decision 708.

At decision 708, the command management module may determine whether a scroll command is detected. If a scroll command is detected, the method 600 may proceed to block 710 and the user interface may scroll displayed items at a set scroll speed based on the selected zoom level. The method 600 may then proceed to decision 712 and continue as described herein. Returning to decision 708, if a scroll command is not detected, the method 600 may proceed directly to decision 712.

At decision 712, the command management module may determine whether an Nth zoom command is detected. If an Nth zoom command is detected, the method 600 may proceed to block 714 and the user interface may zoom to an Nth zoom level. Then, at block 716, the user interface may set a scroll speed based on the Nth zoom level. Thereafter, from block 716, the method 600 may proceed to decision 718 and continue as described herein. Returning to decision 712, if an Nth zoom command is not detected, the method 600 may proceed directly to decision 718.

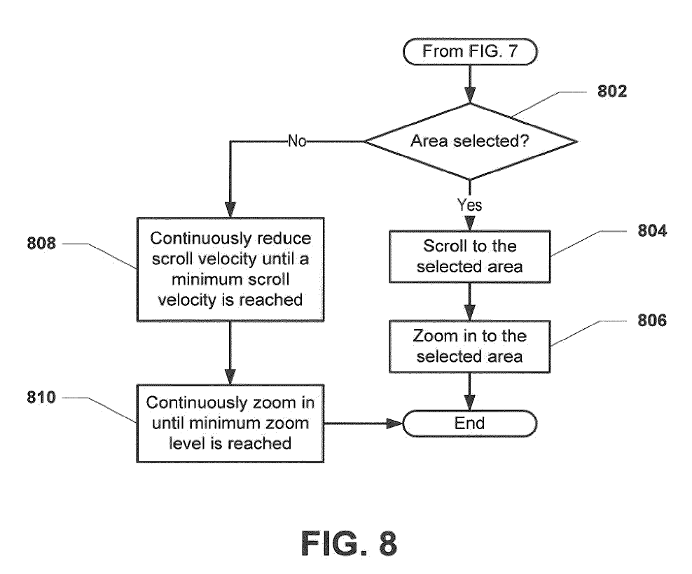

At decision 718, the command management module may determine whether a scroll command is detected. If a scroll command is detected, the method 600 may proceed to block 720 and the user interface may scroll displayed items at a set scroll speed based on the selected zoom level. The method 600 may then proceed to decision 802 of FIG. 8 and continue as described herein. Returning to decision 718, if a scroll command is not detected, the method 600 may proceed directly to decision 802 of FIG. 8.

At decision 802 of FIG. 8, the command management module may determine whether an area of the display is selected. If an area is selected, the method 600 may proceed to block 804 and the user interface may scroll to the selected area. Thereafter, at block 806, the user interface may zoom in to the selected area. The method 600 may then end.

Returning to decision 802, if an area is not selected, the method 600 may proceed to block 808 and the user interface may continuously reduce the scroll velocity until a minimum scroll velocity is reached. Thereafter, at block 810, the user interface may continuously zoom in until a minimum zoom level is reached. The method 600 may then end.

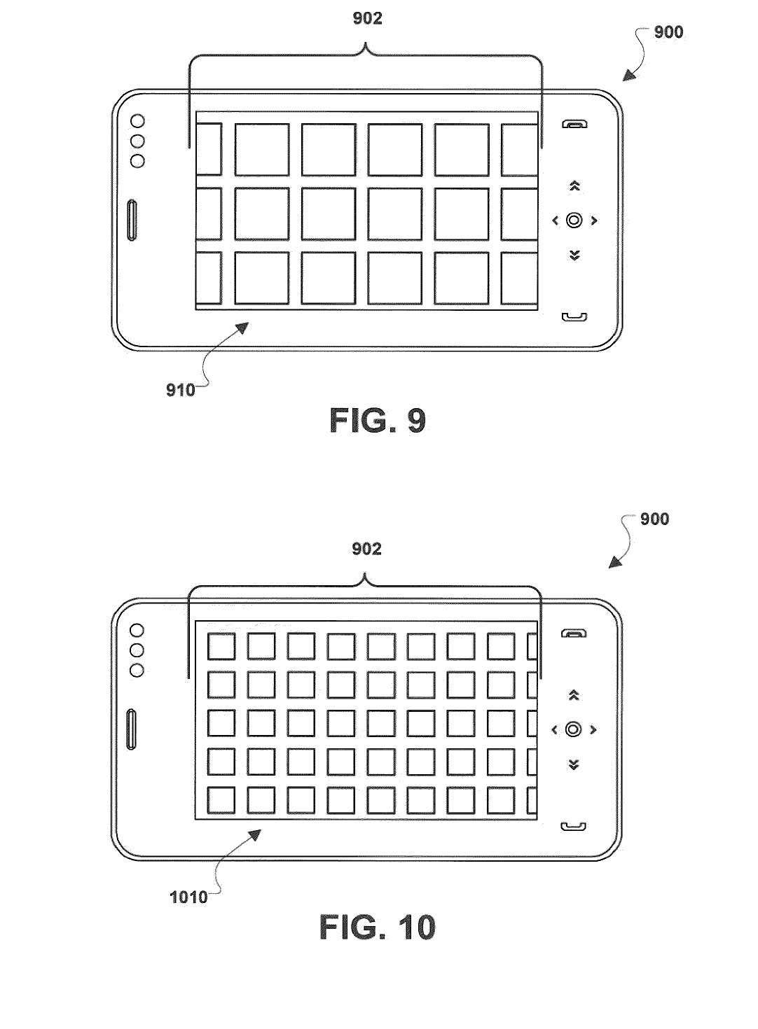

Referring now to FIG. 9 through FIG. 11, a third aspect of a PCD is shown and is generally designated 900. As shown, a plurality of user interface items 902 may be displayed at the PCD 900. The user interface items 902 may include one or more application icons, one or more thumbnails, one or more tiles, or a combination thereof.

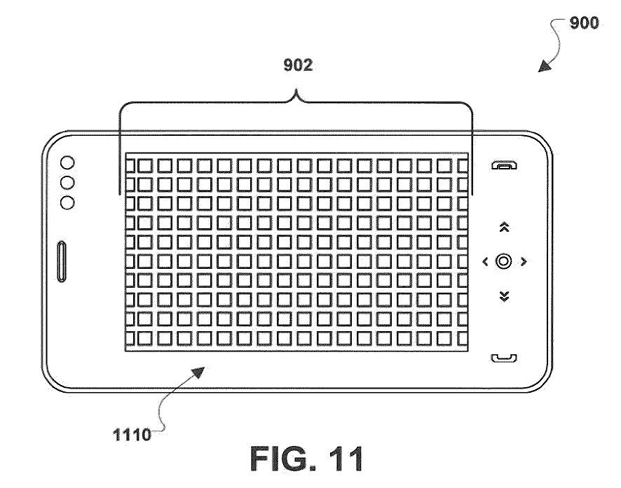

As shown in FIG. 9, the user interface items 902 may be displayed at a first zoom level 910. The first zoom level 910 may be considered a base zoom level, a minimal zoom level, or a starting zoom level, at which the user interface items 902 are shown in their largest sizes. FIG. 10 shows the user interface items 902 at a second zoom level 1010 in which the user interface items 902 are shown in a smaller size. In other words, the second zoom level 1010 is a zoom out from the first zoom level 910. FIG. 11 shows the user interface items 902 at an Nth zoom level 1110 in which the user interface items 902 are shown in yet another smaller size. In other words, the Nth zoom level 1110 is a zoom out from the second zoom level 1010.

In a particular aspect, a first scroll speed may be associated with the first zoom level 910, a second scroll speed may be associated with the second zoom level 1010, and an Nth scroll speed may be associated with the Nth zoom level 1110. In a particular aspect, the more items displayed at the PCD 900, the faster the scroll speed may be. For example, as a user zooms from the first zoom level 910 to the second zoom level 1010, a scroll speed may transition, or change, from the first scroll speed to the second scroll speed. The second scroll speed may be faster than the first scroll speed. Further, as the user zooms from the second zoom level 1010 to the Nth zoom level 1110, the scroll speed may transition, or change, from the second scroll speed to the Nth scroll speed. The Nth scroll speed may be faster from the second scroll speed. As fewer items are displayed, e.g., the zoom level is zoomed in, the scroll speed may slow.

In another aspect, as a user changes scroll speeds, e.g., increases scroll speeds, the zoom level may change. For example, as the user scrolls from the first scroll speed to the second scroll speed, the zoom level may transition, or change, from the first zoom level 910 to the second zoom level 1010. More items may be displayed in the second zoom level 1010 than in the first zoom level 910. Further, as the user scrolls from the second scroll speed to the Nth scroll speed, the zoom level may transition, or change, from the second zoom level 1010 to the Nth zoom level 1110. More items may be displayed in the Nth zoom level 1110 than in the second zoom level 1010. As the scroll speed slows, fewer items may be displayed at the PCD 900.

It is to be understood that the method steps described herein need not necessarily be performed in the order as described. Further, words such as “thereafter,” “then,” “next,” etc. are not intended to limit the order of the steps. These words are simply used to guide the reader through the description of the method steps. Moreover, the methods described herein are described as executable on a portable computing device (PCD). The PCD may be a mobile telephone device, a portable digital assistant device, a smartbook computing device, a netbook computing device, a laptop computing device, a desktop computing device, or a combination thereof.

The methods disclosed herein provide ways to scroll through items displayed on a touch screen user interface. In one aspect, when a user scrolls through a group of items at a first scroll speed, the display can zoom to a first zoom level in which a plurality of items is displayed. When a user scrolls through the items at a second scroll speed, the display can zoom to a second zoom level in which another plurality of items is displayed. If the user scrolls faster, the display may zoom out and a greater number of items may be displayed. If the user scrolls slower, the display may zoom in and a lesser number of items may be displayed. If a user scrolls and does not increase or decrease the scrolls speed, the scroll speed may slowly reduce, as if by friction, to a minimum speed or until the scroll speed halts. As the scroll speed reduces, the display may zoom in and a number of items displayed may decrease.

In another aspect, as a user zooms out and more items are presented to a user, a scroll speed may be increased. Further, as a user continues to zoom out and even more items are presented, the scroll speed may continue to increase. Conversely, as a user zooms in and fewer items are presented to a user, a scroll speed may be decreased. If a user does not zoom in or out, the zoom may slowly zoom in to a minimum zoom level and the scroll speed may slowly reduce, as if by friction, to a minimum speed or until the scroll speed halts.

In one or more exemplary aspects, the functions described may be implemented in hardware, software, firmware, or any combination thereof. If implemented in software, the functions may be stored on or transmitted over as one or more instructions or code on a machine readable medium, i.e., a computer-readable medium. Computer-readable media includes both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Although selected aspects have been illustrated and described in detail, it will be understood that various substitutions and alterations may be made therein without departing from the spirit and scope of the present invention, as defined by the following claims.

What is claimed is:

1. A method of scrolling items at a touch screen display, the method comprising:
detecting a first scroll command;
scrolling at a first scroll speed; and
zooming out to a first zoom level, wherein the first zoom level is associated with the first scroll speed.

2. The method of claim 1, further comprising:
determining whether a second scroll command is detected.

3. The method of claim 2, further comprising:
scrolling at a second scroll speed if a second scroll command is detected.

4. The method of claim 3, further comprising:
zooming out to a second zoom level, wherein the second zoom level is associated with the second scroll speed.

5. The method of claim 4, further comprising:
determining whether an Nth scroll command is detected.

6. The method of claim 5, further comprising:
scrolling at an Nth scroll speed if an Nth scroll command is detected.

7. The method of claim 6, further comprising:
zooming out to an Nth zoom level, wherein the Nth zoom level is associated with the Nth scroll speed.

8. A portable computing device, comprising:
a touch screen display; and
a processor, wherein the processor is operable to:
detect a first scroll command;
scroll at a first scroll speed; and
zoom out to a first zoom level, wherein the first zoom level is associated with the first scroll speed.

9. The device of claim 8, wherein the processor is further operable to:
determine whether a second scroll command is detected.

10. The device of claim 9, wherein the processor is further operable to:
scroll at a second scroll speed if a second scroll command is detected.

11. The device of claim 10, wherein the processor is further operable to:
zoom out to a second zoom level, wherein the second zoom level is associated with the second scroll speed.

12. The device of claim 11, wherein the processor is further operable to:
determine whether an Nth scroll command is detected.

13. The device of claim 12, wherein the processor is further operable to:
scroll at an Nth scroll speed if an Nth scroll command is detected.

14. The device of claim 13, wherein the processor is further operable to:
zoom out to an Nth zoom level, wherein the Nth zoom level is associated with the Nth scroll speed.

15. A portable computing device, comprising:
means for detecting a first scroll command;
means for scrolling at a first scroll speed; and
means for zooming out to a first zoom level, wherein the first zoom level is associated with the first scroll speed.

16. The device of claim 15, further comprising:
means for determining whether a second scroll command is detected.

17. The device of claim 16, further comprising:
means for scrolling at a second scroll speed if a second scroll command is detected.

18. The device of claim 17, further comprising:
means for zooming out to a second zoom level, wherein the second zoom level is associated with the second scroll speed.

19. The device of claim 18, further comprising:
means for determining whether an Nth scroll command is detected.

20. The device of claim 19, further comprising:
means for scrolling at an Nth scroll speed if an Nth scroll command is detected.

21. The device of claim 20, further comprising:
means for zooming out to an Nth zoom level, wherein the Nth zoom level is associated with the Nth scroll speed.

22. A machine readable medium, comprising:
at least one instruction for detecting a first scroll command;
at least one instruction for scrolling at a first scroll speed; and
at least one instruction for zooming out to a first zoom level, wherein the first zoom level is associated with the first scroll speed.

23. The machine readable medium of claim 22, further comprising:
at least one instruction for determining whether a second scroll command is detected.

24. The machine readable medium of claim 23, further comprising:
at least one instruction for scrolling at a second scroll speed if a second scroll command is detected.

25. The machine readable medium of claim 24, further comprising:
at least one instruction for zooming out to a second zoom level, wherein the second zoom level is associated with the second scroll speed.

26. The machine readable medium of claim 25, further comprising:
at least one instruction for determining whether an Nth scroll command is detected.

27. The machine readable medium of claim 26, further comprising:
at least one instruction for scrolling at an Nth scroll speed if an Nth scroll command is detected.

28. The machine readable medium of claim 27, further comprising:
at least one instruction for zooming out to an Nth zoom level, wherein the Nth zoom level is associated with the Nth scroll speed.

29. A method of scrolling items on a touch screen user interface, the method comprising:
detecting a first zoom command;
zooming to a first zoom level; and
setting a first scroll speed, wherein the first scroll speed is associated with the first zoom level.

30. The method of claim 29, further comprising:
detecting a scroll command; and
scrolling a plurality of displayed items at the first scroll speed.

31. The method of claim 29, further comprising:
detecting a second zoom command;
zooming to a second zoom level; and
setting a second scroll speed, wherein the second scroll speed is associated with the second zoom level.

32. The method of claim 31, further comprising:
detecting a scroll command; and
scrolling a plurality of displayed items at the first scroll speed.

33. The method of claim 32, further comprising:
detecting an Nth zoom command;
zooming to an Nth zoom level; and
setting an Nth scroll speed, wherein the Nth scroll speed is associated with the second zoom level.

34. The method of claim 33, further comprising:
detecting a scroll command; and
scrolling a plurality of displayed items at the first scroll speed.

35. A portable computing device, comprising:
a touch screen display;
a processor, wherein the processor is operable to:
detect a first zoom command;
zoom to a first zoom level; and
set a first scroll speed, wherein the first scroll speed is associated with the first zoom level.

36. The device of claim 35, wherein the processor is further operable to:
detecting a scroll command; and
scrolling a plurality of displayed items at the first scroll speed.

37. The device of claim 35, wherein the processor is further operable to:
detecting a second zoom command;
zooming to a second zoom level; and
setting a second scroll speed, wherein the second scroll speed is associated with the second zoom level.

38. The device of claim 37, wherein the processor is further operable to:
detecting a scroll command; and
scrolling a plurality of displayed items at the first scroll speed.

39. The device of claim 38, wherein the processor is further operable to:
detecting an Nth zoom command;
zooming to an Nth zoom level; and
setting an Nth scroll speed, wherein the Nth scroll speed is associated with the second zoom level.

40. The device of claim 39, wherein the processor is further operable to:
detecting a scroll command; and
scrolling a plurality of displayed items at the first scroll speed.

41. A portable computing device, comprising:
means for detecting a first zoom command;
means for zooming to a first zoom level; and
means for setting a first scroll speed, wherein the first scroll speed is associated with the first zoom level.

42. The device of claim 41, further comprising:
means for detecting a scroll command; and
means for scrolling a plurality of displayed items at the first scroll speed.

43. The device of claim 41, further comprising:
means for detecting a second zoom command;
means for zooming to a second zoom level; and
means for setting a second scroll speed, wherein the second scroll speed is associated with the second zoom level.

44. The device of claim 43, further comprising:
means for detecting a scroll command; and
means for scrolling a plurality of displayed items at the first scroll speed.

45. The device of claim 44, further comprising:
means for detecting an Nth zoom command;
means for zooming to an Nth zoom level; and
means for setting an Nth scroll speed, wherein the Nth scroll speed is associated with the second zoom level.

46. The device of claim 45, further comprising:
means for detecting a scroll command; and
means for scrolling a plurality of displayed items at the first scroll speed.

47. A machine readable medium, comprising:
at least one instruction for detecting a first zoom command;
at least one instruction for zooming to a first zoom level; and
at least one instruction for setting a first scroll speed, wherein the first scroll speed is associated with the first zoom level.

48. The machine readable medium of claim 47, further comprising:
at least one instruction for detecting a scroll command; and
at least one instruction for scrolling a plurality of displayed items at the first scroll speed.

49. The machine readable medium of claim 47, further comprising:
at least one instruction for detecting a second zoom command;
at least one instruction for zooming to a second zoom level; and
at least one instruction for setting a second scroll speed, wherein the second scroll speed is associated with the second zoom level.

50. The machine readable medium of claim 49, further comprising:
at least one instruction for detecting a scroll command; and
at least one instruction for scrolling a plurality of displayed items at the first scroll speed.

51. The machine readable medium of claim 50, further comprising:
at least one instruction for detecting an Nth zoom command;
at least one instruction for zooming to an Nth zoom level; and
at least one instruction for setting an Nth scroll speed, wherein the Nth scroll speed is associated with the second zoom level.

52. The machine readable medium of claim 51, further comprising:
at least one instruction for detecting a scroll command; and
at least one instruction for scrolling a plurality of displayed items at the first scroll speed.
